(19) United States
(12) Patent Application Publication
(10) Pub. No.: US 2015/0033480 A1
(43) Pub. Date: Feb. 5, 2015

(54) WOOD COLORING WITH FUNGI AND THE TREATING PROCESS

(71) Applicants: Dian-Qing Yang, Quebec (CA); Manon Gignac, St-Redempteur (CA)

(72) Inventors: Dian-Qing Yang, Quebec (CA); Manon Gignac, St-Redempteur (CA)

(21) Appl. No.: 14/001,375

(22) PCT Filed: Mar. 2, 2012
(86) PCT No.: PCT/CA12/00196

§ 371 Date: Mar. 27, 2014

Related U.S. Application Data
(60) Provisional application No. 61/449,160, filed on Mar. 4, 2011.

(51) Int. Cl. B27K 5/02

(52) U.S. Cl. CPC B27K 5/02
USPC 8/402

(57) ABSTRACT

Wood color has an important economical impact on wood products. The hardwood lumber industry has shown a particular increase in demand by their customers for wood with an attractive, consistent and specified color. Fungi are a specific group of micro-organisms that can affect wood color. Some fungi produce various colourful pigments during their growth and can produce a preferable uniform color on wood products. The present invention includes methods to use selected fungi for producing various commercially desirable colors on wood and wood products. The methods include manners of fungal selection, culturing conditions, wood treating procedure, incubation timeframe, and drying process. The present invention also describes the wood produced by the method.

### FIELD OF THE INVENTION

The present invention relates to producing a desirable wood color with particular fungal species and the lumber treating process with the fungi.

### BACKGROUND

Wood color is produced by progressive accumulation of wood cells with a complex of diverse substances called extractives during tree growing. Pigmented extractives determine most of the visual appearance quality of the hardwood species; therefore, they affect wood usefulness and value of the wood products. Many recognizable and commercially desirable qualities of the heartwood such as cherry, walnut and rosewood etc are a result of the presence of pigmented extractives. The presence of the pigmented extractives is mostly distributed in the heartwood of trees. In some species such as maple or spruce the extractives are light color, and the heartwood of these species remains light color similar to the sapwood; these wood species are called light heartwood trees. In some other species such as oak or cedar the extractives presented in heartwood are a dark-color; therefore, the heartwood has various color intensities and can be visually recognized from sapwood. These trees are described as regular heartwood trees.

Fungal infection of wood can cause wood color change (lighter or darker). The well-known fungal discoloration of wood is called blue stain. Blue stain is caused by a particular group of fungi that commonly attack only the sapwood of trees to bluish or greyish discoloration of the wood; therefore, it is also called sapstain. This type of fungi utilizes simple sugars and starches presented in the sapwood as nutrients and produce dark pigment called melanin during their growth. The wood discoloration caused by fungal melanin may cover the whole sapwood or may appear as streaks or patches of bluish to black intensities. However, the bluish black wood color resulted from these fungi is not desirable for wood end users. Most studies on wood blue stain are focused on preventing or controlling color development on wood products. One of such approaches is inoculating wood with a colorless mutant of a sapstain fungus such as Ophiostoma piliferum, and the preoccupation of wood surfaces by the colorless fungus can prevent later invasion of wood by staining fungi and thereafter wood color change. No study has been conducted to artificially inoculate blue stain fungi to produce bluish black wood color far high wood value use.

Another wood color change caused by fungal infection is a green color caused by Chlorociboria species. The wood discoloration is caused by the production of a fungal pigment xylindein, which is classified as a napthaquinone. The naturally green-stained wood had been used as woodcrafts in European countries since 14^{th}-15^{th} century.

Wood decay can also change wood color. A well known example is called spalted wood that is in high demand in the decorative wood market. Spalted wood is caused by certain decay fungi growing in wood (white-rot). The decay fungal attack can cause random patches of contrasting colors to appear on the surface of some hardwoods such as maple and birch. In addition, when two or more competing fungi are meeting together in wood, it may create brown to black zone lines on wood in the border of each fungal territories. In this way, spalted wood forms map-like figures of different shapes and color contrasts. It may also produce unusual multicoloured streaks on wood caused by reaction between the wood and decay fungi. However, the pattern and color changes produced on spalted wood by these decay fungi are not predictable and repeatable.

Most common methods for coloring wood products are using pigments or dye materials which are carried either in a liquid solution or as a dispersion.

### SUMMARY

In accordance with one aspect of the present invention, there is provided a method of coloring and treating wood with a pigmented fungal species, the method comprising: providing the fungal species in an active form; providing the wood to be treated; applying the active form of the fungal species to the wood to produce a treated wood; incubating the treated wood for a period of time; drying the treated wood.

In accordance with another aspect of the method described herein, the fungal species provided is selected from the group consisting of Penicillium variabile; Fusarium culmorum; Coryne microspora; Diatrypella placenta; Arthrographis cuboidea; Poria aurea; Corticium polosum; Lentinus cyathiformis; Lecythophora hoffmannii; Tyromyces balsameus; Trogia crispa; Polyporus dryophilus; Polyporus dryophilus var. vulpinus; Peniophora piceae; Sporotrichum dimorphosporum; Gliocladium verticilloides; Nectria ochroleuca; Trichoderma atroviride; Trichoderma sp; Verticillium sp; Chlorosplenium aeruginascens; Scytalidium lignicola; Ophiostoma piceae; Aureobasidium pullulans; Phialophora alba; Penicillium expansum; Penicillium implicatum; Fusarium verticillioides; Dactylium dendroides; Phialemonium dimorphosporum, Fusarium oxysporum, Ascocoryne cylichnium; Cephalotheca purpurea and combinations thereof.

In accordance with yet another aspect of the method described herein, the step of providing the fungal species in an active form comprises incubating the fungal species to produce a fungal culture, homogenizing the culture to produce a suspension.

In accordance with still another aspect of the method described herein, the suspension produced comprises a concentration of spores/mycelia fragments per ml of suspension of at least about 1×10⁵.

In accordance with yet still another aspect of the method described herein, the suspension produced comprises a concentration of spores/mycelia fragments per ml of suspension of about but not limits from 1×10⁶ to 1×10⁸.

In accordance with a further aspect of the method described herein, the wood provided to be treated is sapwood and heartwood of sugar maple, white birch and yellow birch but may extend to all other hardwood and softwood species.

In accordance with yet a further aspect of the method described herein, the step of applying the active form of the fungal species to the wood is by dipping, by spraying or by brushing.

In accordance with stiff a further aspect of the method described herein, the step of applying the active form of the fungal species to the wood is by dipping.

In accordance with yet still a further aspect of the method described herein, the step of incubating the treated wood for a period of time is for more than 1 week at a temperature from 5° C. to 35° C. and a relative humidity at least 75% or higher.

In accordance with one embodiment of the method described herein, the treated wood is incubated at 25° C. and 75% RH for 1 to 4 weeks.

In accordance with another embodiment of the method described herein, the treated wood is dried at a temperature from 50° C. to 105° C.

In accordance with yet another embodiment of the method described herein, the wood color change is evaluated visually or with a colorimeter.

In accordance with still another aspect of the present invention, there is provided a fungal species treated wood product produced by a method comprising: providing the fungal species in an active form; providing the wood to be treated; applying the active form of the fungal species to the wood to produce a treated wood; incubating the treated wood for a period of time; drying the treated wood.

In accordance with another aspect of the product described herein, the fungal species provided is selected from the group consisting of Penicillium variabile; Fusarium culmorum; Coryne microspora; Diatrypella placenta; Arthrographis cuboidea; Poria aurea; Corticium polosum; Lentinus cyathiformis; Lecythophora hoffmannii; Tyromyces balsameus; Trogia crispa; Polyporus dryophilus; Polyporus dryophilus var. vulpinus; Peniophora piceae; Sporotrichum dimorphosporum; Gliocladium verticilloides; Nectria ochroleuca; Trichoderma atroviride; Trichoderma sp; Verticillium sp; Chlorosplenium aeruginascens; Scytalidium lignicola; Ophiostoma piceae; Aureobasidium pullulans; Phialophora alba; Penicillium expansum; Penicillium implicatum; Fusarium verticillioides; Dactylium dendroides; Phialemonium dimorphosporum, Fusarium oxysporum, Ascocoryne cylichnium; Cephalotheca purpurea and combinations thereof.

This invention provides methods and manufacturing processes to produce various desirable wood colors with different particular fungal species for high wood value use by 1) using selected fungal species to produce a particular desirable wood color, and 2) producing wood color changes predictable, uniform, stable and repeatable.

### DESCRIPTION OF THE DRAWINGS

FIG. 1 is a histogram illustrating a brown wood color variation between sapwood and heartwood produced by Trogia crispa (FTK 473C) according to one embodiment of the present invention;

FIG. 2 is a histogram illustrating a grey wood color variation between sapwood and heartwood caused by Penicillium expansum (FTK 828A) according to one embodiment of the present invention;

FIG. 3 is a histogram illustrating a black wood color variation between sapwood and heartwood caused by Aureobasidium pullulans (FTK 1321) according to one embodiment of the present invention;

FIG. 4 is a histogram illustrating a purple wood color variation between sapwood and heartwood caused by Dactylium dendroides (FTK 597A) according to one embodiment of the present invention;

FIG. 5 is a histogram illustrating a red wood color variation between sapwood and heartwood Arthrographis cuboidea (FTK 706B) according to one embodiment of the present invention;

FIG. 6 is a histogram illustrating a green wood color variation between sapwood and heartwood Chlorosplenium aeruginascens (FTK 401A) according to one embodiment of the present invention;

FIG. 7 is a photograph of black coloration of sugar maple sapwood (left) and heartwood caused by Aureobasidium pullulans according to one embodiment of the present invention;

FIG. 8 is a photograph of purple coloration of yellow birch sapwood (left) and heartwood caused by Dactylium dendroides according to one embodiment of the present invention;

FIG. 9 is a photograph of red coloration of white birch sapwood (left) and heartwood caused by Arthrographis cuboidea according to one embodiment of the present invention;

FIG. 10 is a photograph of green coloration of sugar maple sapwood (left) and heartwood caused by Chlorosplenium aeruginascens according to one embodiment of the present invention.

### DETAILED DESCRIPTION OF THE INVENTION

### Example 1

### Selection of Fungal Species for Coloring

Selection of fungal species for coloring wood was performed in Petri plates (85 mm in diameter) holding 20 ml of a 2% (w/v) malt extract agar medium in each plate. One mycelia plug (5 mm in diameter) was cut from each fungal colony and transferred to the middle of each plate. The plates were sealed with a Parafilm and incubated at 25° C. and 75% RH for 14 days. The colors produced by these fungi on agar were visually evaluated. Based on the principal colors produced by these fungi, 33 fungal species were selected for testing on wood. The principal colors are pink, red, brown, orange, yellow, green, black, blue and purple. 1 to 5 fungal species per color were selected for the test on wood. The selected fungal species and associated colors in agar plates are shown in Table 1.

All these fungal species came from the Culture Collection of Wood-inhabiting Fungi (FTK) holding by FPInnovations, Quebec, Canada. All fungal cultures were maintained in a liquid nitrogen reservoir for cryopreservation at −198° C. before use.

### Example 2

### Preparation of Fungal Solutions and Wood Specimens for Coloring

The selected fungal species were retrieved from the liquid nitrogen reservoir and grown on a 2% (w/v) malt extract agar medium in Petri plates at 25° C. for one week. Mycelia plugs (5 mm in diameter) were cut from each fungal colony and transferred 3 plugs to each 125 ml flask containing 50 ml of a sterile 2% (w/v) Difco malt extract broth (Becton, Dickinson and Company, Sparks, Md., USA) in distilled water. After incubation, the fungal cultures were homogenized 3 times (30 seconds per time) with a homogenizer into a fine mycelia fragments and spore suspension. One drop of the suspension was loaded on a hemacytometer and spores and mycelia fragments in the solution were counted under a microscope. Fungal suspensions having at least 1×10⁵ spores/mycelia fragments per ml of suspension have been found to be effective. However, concentrations of the present fungal suspensions were determined to be 1×10⁶ to 1×10⁸ spores/mycelia fragments per ml of the solution. These fungal suspensions were used immediately to treat wood specimens.

Fresh log sections of sugar maple (Acer saccharum Marshall), white birch (Betula papyrifera Marshall) and yellow birch (Betula alleghaniensis Britton) were provided by a local Quebec company. The sapwood and heartwood of log sections were identified and cut separately into wood specimens at the size of 60 mm×20 mm×5 mm. A total of 792 wood samples were prepared from these 3 wood species for testing selected 33 fungal species.

### Example 3

### Treatment of Wood Specimens and Evaluation

Wood specimens were placed in containers based on wood species and autoclaved at 121° C. for 10 minutes. After cooling, wood specimens were dipped for 30 seconds in a fungal solution. 4 specimens per treatment. Following the treatment, two pieces of specimens were placed on a W-shaped glass support sitting over 2 layers of wet filter paper in a Petri plate. These plates were incubated in a growth chamber set at 25° C. and 75% RH. Wood specimens were visually inspected for wood color change each week up to 4 weeks. At the end of the test, half amount of the wood specimens was dried at 50° C. and another half was dried at 105° C. The final wood colors after drying were measured with a colorimeter.

The wood coloring with selected fungal species is shown in Table 1. In most cases, one fungal species colored all three wood species tested into a similar color. In addition to wood species, most of the fungal species colored sapwood and heartwood of a wood species at a similar intensive level. Therefore, wood colors shown in Table 1 represented the major color observed from all wood specimens treated with each fungal species.

Because of the interference of wood cells, the colors shown on agar may or may not be the same as the one shown on wood. For example, agar and wood were both colored into green by Verticillium sp. (FTK 164C) and Chlorosplenium aeruginascens (FTK 401A); colored into purple by Dactylium dendroides (FTK 597A) and Phialemonium dimorphosporum (FTK 669A); colored into brown by Trogia crispa (FTK 473C) and Polyporus dryophilus var. vulpinus (FTK 483A); and colored into black by Aureobasidium pullulans (FTK 1321). Some fungal species produced different colors on agar and on wood. For example, Fusarium culmorum (FTK 750A) produced red color on agar, but purple on wood; and Fusarium oxysporum (FTK 31A) produced dark purple color on agar, but brown on wood. Other fungal species produced a similar color on agar, but different colors on wood. For examples, both Phialophora alba (FTK 772A) and Penicillium expansum (FTK 828A) produced pink pigments on agar, but on wood the former caused light brown and the later caused grayish color. Still some fungal species produced different colors on agar, but a similar color on wood. For example, Arthrographis cuboidea (FTK 706B) produced light brown and Poria aurea (FTK 110A) produced brown color on agar, but both species produced red color on wood. There were several fungal species that produced pigments on agar but not on wood such as, in agar plate cultures, Penicillium variabile (FTK 659B) produced red pigment, Coryne microspora (FTK 239A) produced light brown pigment, and Sporotrichum dimorphosporum (FTK 306D) produced yellow pigment, while none of them produced any color on wood.

Wood specimens dried at different temperatures, in general, did not significantly change principal wood colors but significantly changed color lightness. Those wood specimens dried at 105° C. were significantly darker than those dried at 50° C.

TABLE 1
Fungal coloring from agar plate test and on wood specimens

| Num- | Fungal | | Color on | Color on |
|---|---|---|---|---|
| ber | code | Fungal species | agar | wood |
| 1 | FTK | Penicillium variabile | Red | No |
| | 659B | Sopp | | coloring |
| 2 | FTK | Fusarium culmorum | Red | Purple |
| | 750A | (W. G. Sm.) Sacc. | | |
| 3 | FTK | Coryne microspora | Light | No |
| | 239A | Ellis & Everh. | brown | coloring |
| 4 | FTK | Diatrypella placenta | Light | No |
| | 430A | Rehm | brown | coloring |
| 5 | FTK | Arthrographis cuboidea | Light | Red |
| | 706B | (Sacc. et Ellis) Sigler | brown | |
| 6 | FTK | Poria aurea | Brown | Red |
| | 110A | Peck | | |
| 7 | FTK | Corticium polosum | Brown | Brown |
| | 534A | Burt | | |
| 8 | FTK | Lentinus cyathiformis | Brown | Brown |
| | 795A | Bres. | | |
| 9 | FTK | Lecythophora hoffmannii (van | Brown | 8rown |
| | 893A | Beyma) W. Gams & McGinnis | | |
| 10 | FTK | Tyromyces balsameus | Dark | Brown |
| | 79A | (Peck) Murrill | brown | |
| 11 | FTK | Trogia crispa | Dark | Brown |
| | 473C | Fr. | brown | |
| 12 | FTK | Polyporus dryophilus | Dark | Brown |
| | 482B | Berk. | brown | |
| 13 | FTK | Polyporus dryophilus var. | Dark | Brown |
| | 483A | vulpinus (Fr.) Overh. | brown | |
| 14 | FTK | Peniophora piceae | Dark | Brown |
| | 840A | (Pers.) J. Erikss. | brown | |
| 15 | FTK | Sporotrichum dimorphosporum | Yellow | No |
| | 306D | v. Arx. | | coloring |
| 16 | FTK | Gliocladium verticilloides | Yellow | Grayish |
| | 790A | Pidoplichko | | yellow |
| 17 | FTK | Nectria ochroleuca | Yellow | Grayish |
| | 843C | (Schweinitz) Berkeley | | yellow |
| 18 | FTK | Trichoderma alroviride | Yellowish | Grayish |
| | 585E | P. Karst. | orange | brown |
| 19 | FTK | Trichoderma sp. | Yellowish | Yellowish |
| | 872B | | orange | brown |
| 20 | FTK | Verticillium sp. | Green | Green |
| | 164C | | | |
| 21 | FTK | Chlorosplenium aeruginascens | Green | Green |
| | 401A | (Nyl.) Karst | | |
| 22 | FTK | Scytalidium lignicola | Dark | Grayish |
| | 197P | Pesante | blue | blue |
| 23 | FTK | Ophiostoma piceae (Münch) | Dark | Grayish |
| | 387AN | Syd., H. & P. Syd. | blue | brown |
| 24 | FTK | Aureobasidium pullulans | Black | Black |
| | 132I | (deBary) Arnaud | | |
| 25 | FTK | Phialophora alba | Pink | Light |
| | 772A | von Beyma | | Brown |
| 26 | FTK | Penicillium expansum | Pink | Gray |
| | 828A | Link | | |
| 27 | FTK | Penicillium implicatum | Pink | Green |
| | 837A | Biourge | | |
| 28 | FTK | Fusarium verticillioides | Light | Light |
| | 754A | (Sacc.) Nirenberg | purple | Brown |
| 29 | FTK | Dactylium dendroides | Purple | Purple |
| | 597A | (Bulliard) Fr. | | |
| 30 | FTK | Phialemonium dimorphosporum | Purple | Purple |
| | 669A | W. Gams & W. B. Cooke | | |
| 31 | FTK | Fusarium oxysporum | Dark | Brown |
| | 31A | Schlechtend.: Fr. | purple | |
| 32 | FTK | Ascocoryne cylichnium | Dark | Brownish |
| | 392A | (Tul.) Korf | purple | purple |
| 33 | FTK | Cephalotheca purpurea | Dark | Light |
| | 433A | (Shear) Chesters | purple | Brown |

### Example 4

### Matching Color on Sapwood and Heartwood

Color evaluation of sapwood and heartwood wood blocks after fungal treatment and drying were performed with a colorimeter Color-guide 45/0 de SYK-Gardner USA.

Colors are perceived as combinations of green and yellow, red and blue, and red and yellow. Based upon the equation of the CIE 1976 from Haegen et al.:

L*a*b* color space system, colors are assigned to a rectangular coordinate system. The color coordinates are L* the lightness coordinate, a* the red/green coordinate (+a* indicating red and −a* indicating green), and b* the yellow*/blue coordinate (+b* indicating yellow and −b* indicating blue). Because the CIE L*a*b* colors space system is three-dimensional, it can often be difficult to relate actual differences in color values to visually perceived differences. One method developed for examining color differences uses the color metric difference (ΔE*_{ab}) where:

ΔE*_{ab}={square root over (((L*₁−L*₂)²+(a*₁−a₂)²+(b*₁−b*₂)²))}

Mathematically, the color metric difference (ΔE*_{ab}) is the Euclidean distance between two colors, L*₁a*₁b*₁ and L*₂a*₂b*₂. It is relatively proportional to color differences perceived by human observers (Billmeyer and Saltzman 1981). Haeghen et al. (2000) determine that ΔE*_{ab} color difference values less than 3 are considered unnoticeable to the human eye.

In a study on white beech looking at color problems with the drying process (Rodolfo et al. 2007), the magnitude of ΔE*_{ab} was classified according to the grading rules as follows:

0.2<ΔE*_{ab}=Not visible difference;

0.2<ΔE*_{ab}<2=Small difference:

2<ΔE*_{ab}<3=Colour difference visible with high quality screen;

3<ΔE*_{ab}<6=Colour difference visible with medium quality screen;

6<ΔE*_{ab}<12=High colour difference; and

ΔE*_{ab}>12=Different colours.

With this classification, ΔE*_{ab}>6 correspond to a high color difference and if>12 as different colours.

Color variations (ΔE*_{ab}) of all fungal treated wood samples compared with the untreated controls are presented in Table 2. All of the fungal treatments lead to a significant color change of the tree hardwood species, both on sapwood and heartwood, with ΔE*_{ab} value going from 25.2 and up to 73.6.

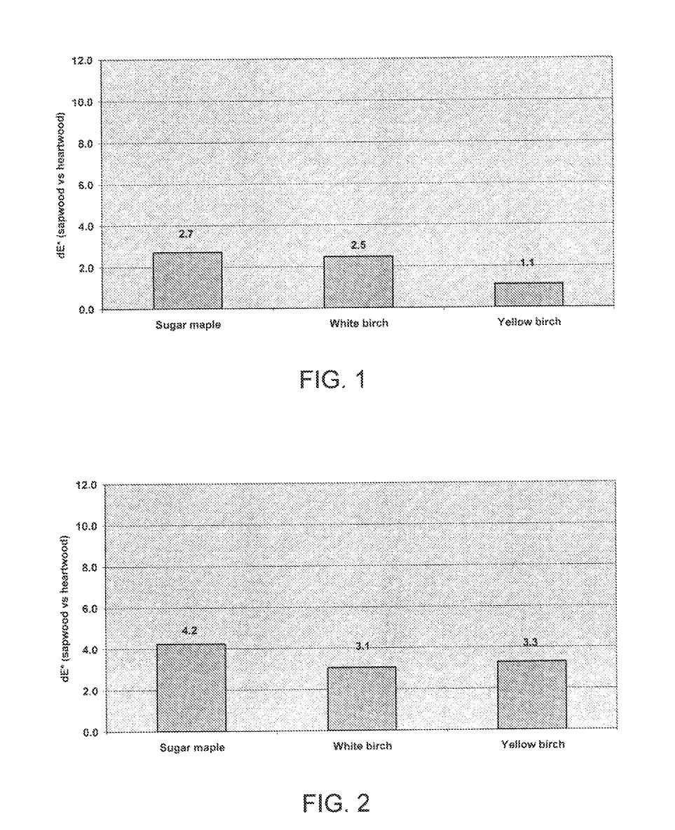

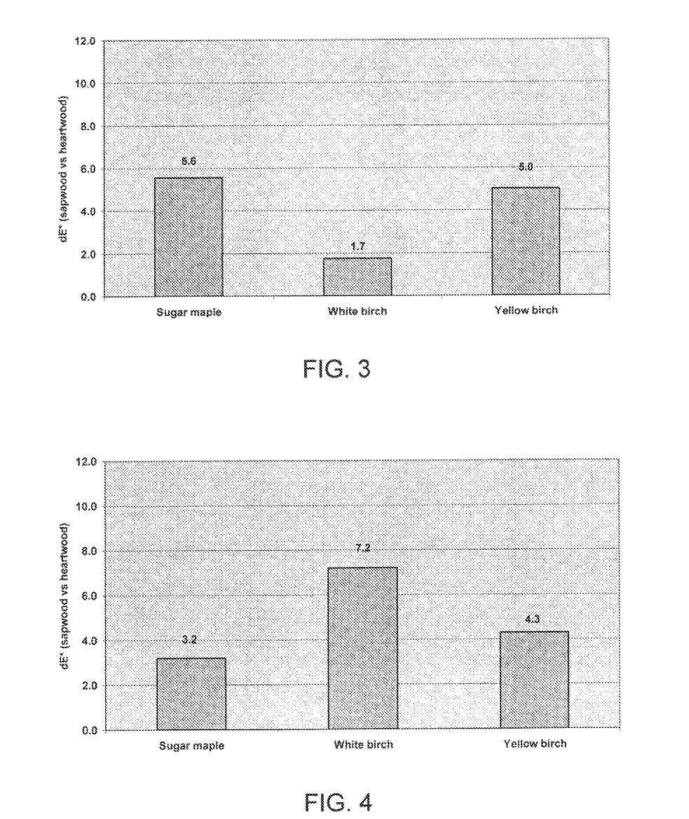

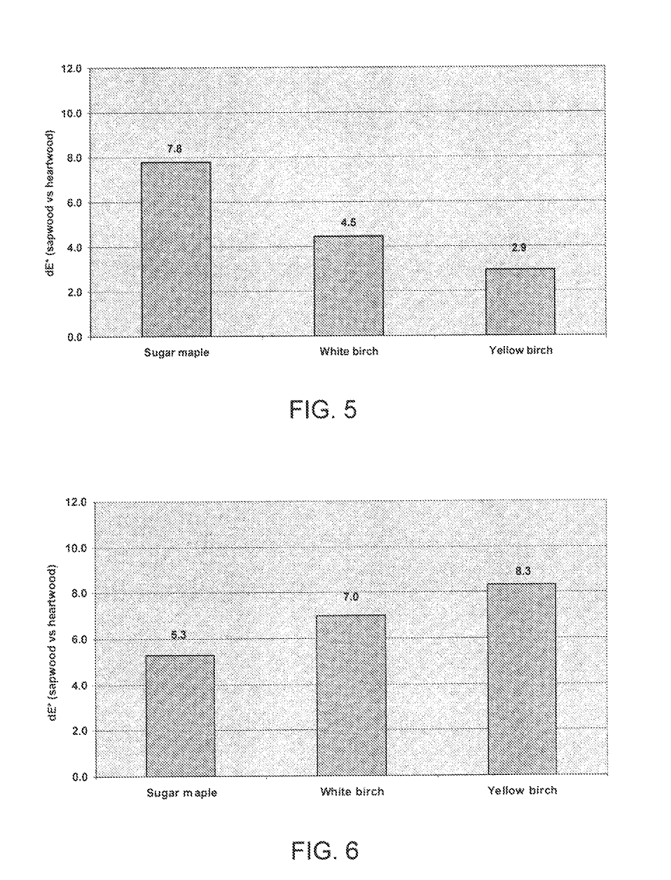

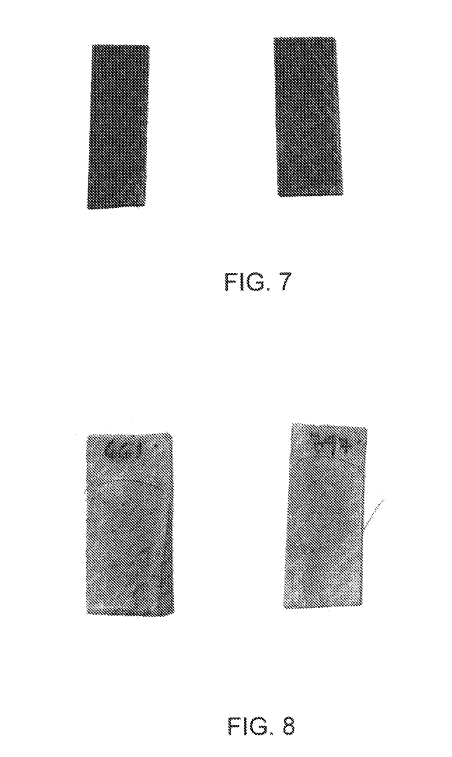

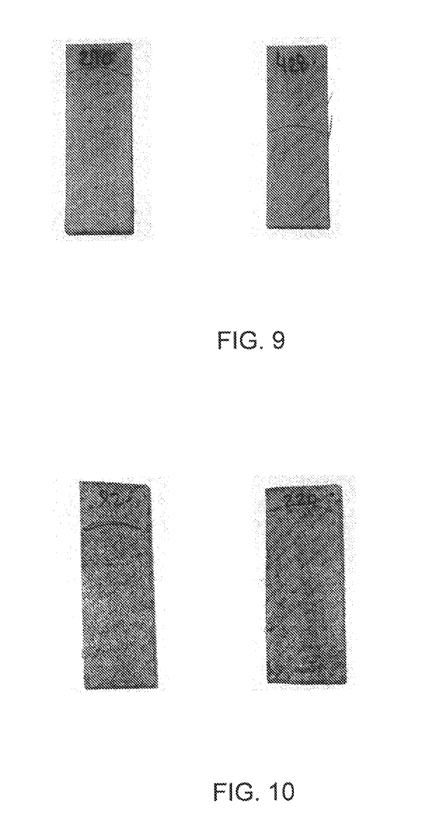

We also looked at the wood color variation between sapwood section and heartwood section of a same wood species (FIGS. 1 to 6). Most of the fungal treated samples had a ΔE*_{ab} value below 10 with a least one representative of each wood color below 3, the critical level of what could be seen by the human eye. Pictures of different wood colors obtained by fungal coloration are presented in FIG. 7 to 10.

TABLE 2
Wood color change (ΔE*_{ab}) after fungal treatment

| | | | Sugar | | White | | Yellow | |
|---|---|---|---|---|---|---|---|---|
| | | | maple | | birch | | birch | |
| | Fungal | | heart- | sap- | heart- | sap- | heart- | sap- |
| Number | code | Fungal name | wood | wood | wood | wood | wood | wood |
| 6 | FTK 110A | Poria aurea | 57.1 | 52.5 | 56.5 | 55.1 | 60.3 | 46.4 |
| 24 | FTK 132I | Aureobsidium | 35 | 33.5 | 46.1 | 44.5 | 47.6 | 43 |
| | | pullulans | | | | | | |
| 20 | FTK 164C | Verticillium sp. | 59.4 | 55.8 | 56.1 | 59.5 | 57.4 | 57.7 |
| 22 | FTK 197P | Scytalidium | 46.1 | 52.1 | 45.8 | 39.4 | 51.5 | 41.9 |
| | | lignicola | | | | | | |
| 3 | FTK 239A | Coryne microspora | 64.7 | 65.9 | 67.3 | 66.7 | 63.9 | 68.1 |
| 15 | FTK 306D | Sporatrichum | 62.7 | 66.5 | 63.2 | 68.8 | 58.7 | 68 |
| | | dimorphosporum | | | | | | |
| 31 | FTK 31A | Fusarium | 55.2 | 61.5 | 61.9 | 59.5 | 58.7 | 60.5 |
| | | oxysporum | | | | | | |
| 23 | FTK | Ophiostoma piceae | 59.7 | 60.5 | 61.1 | 53.6 | 54.6 | 54.1 |
| | 387AN | | | | | | | |
| 32 | FTK 392A | Ascocorune | 40.2 | 25.2 | 55.7 | 54.5 | 54.6 | 49.3 |
| | | cylichnium | | | | | | |
| 21 | FTK 401A | Chlorosplenium | 57.3 | 62.8 | 59 | 61.5 | 59.1 | 57.2 |
| | | aeruginascens | | | | | | |
| 4 | FTK 430A | Diatrypella placenta | 64.8 | 70.9 | 69.6 | 70.1 | 61.9 | 70.4 |
| 33 | FTK 433A | Cephalotheca | 60.3 | 63.8 | 60.9 | 58.8 | 56.6 | 62.7 |
| | | purpurea | | | | | | |
| 11 | FTK 473C | Trogia crispa | 56.2 | 60.8 | 59.2 | 58.3 | 57.1 | 56.6 |
| 12 | FTK 482B | Polyporus | 64.6 | 67.5 | 66.7 | 61.8 | 64.8 | 66.7 |
| | | dryophilus | | | | | | |
| 13 | FTK 483A | Polyporus | 41.3 | 65.8 | 42.6 | 44.1 | 47.9 | 58.2 |
| | | dryophilus var. | | | | | | |
| | | vulpinus | | | | | | |
| 7 | FTK 534A | Corticium polosum | 65.6 | 61.3 | 65.1 | 66 | 54.1 | 60.3 |
| 18 | FTK 585E | Trichoderma | 62.7 | 68.6 | 57.3 | 63.8 | 55.6 | 64.6 |
| | | atroviride | | | | | | |
| 29 | FTK 597A | Dactylium | 64.2 | 65.6 | 55.9 | 52.3 | 54.6 | 51.1 |
| | | dendroides | | | | | | |
| 1 | FTK 659B | Penicillium variabile | 65.2 | 69.3 | 61 | 66.1 | 64.4 | 63.6 |
| 30 | FTK 669A | Phialemonium | 49.7 | 44.9 | 48.4 | 65 | 51 | 59.3 |
| | | dimorphosporum | | | | | | |
| 5 | FTK 706B | Arthrographis | 42 | 48 | 37.1 | 39.9 | 42.2 | 40.4 |
| | | cuboidea | | | | | | |
| 2 | FTK 750A | Fusarium culmorum | 61.4 | 52.1 | 61.4 | 62 | 59.3 | 58.9 |
| 28 | FTK 754A | Fusarium | 54.8 | 60.6 | 65.3 | 63.3 | 57.2 | 60.6 |
| | | verticillioides | | | | | | |
| 25 | FTK 772A | Phialophora alba | 68 | 73.6 | 65.9 | 67.3 | 60.8 | 69.6 |
| 16 | FTK 790A | Gliocladium | 66 | 68 | 65.1 | 71.8 | 67.4 | 69.3 |
| | | verticilloides | | | | | | |
| 8 | FTK 795A | Lentinus | 61.4 | 59.3 | 57.4 | 63.1 | 54.4 | 57.2 |
| | | cyathiformis | | | | | | |
| 10 | FTK 79A | Tyromoces | 64.6 | 66 | 71 | 70 | 64.3 | 66.3 |
| | | balsameus | | | | | | |
| 26 | FTK 828A | Penicillium | 60.5 | 59.3 | 63.8 | 61 | 65.5 | 62.1 |
| | | expansum | | | | | | |
| 27 | FTK 837A | Penicillium | 52.3 | 52.1 | 53.2 | 51.3 | 48.1 | 58.9 |
| | | implicatum | | | | | | |
| 14 | FTK 840A | Peniophora piceae | 54.4 | 60.3 | 59.4 | 62.9 | 56.2 | 68.7 |
| 17 | FTK 843C | Nectria ochroleuca | 63.2 | 71.9 | 61.7 | 72.4 | 64.6 | 68.6 |
| 19 | FTK 872B | Trichoderna sp. | 58.5 | 71.3 | 61.7 | 65.7 | 57.7 | 66.2 |
| 9 | FTK 893A | Lecythophora | 65.3 | 69.5 | 64.6 | 69.7 | 65.2 | 66.4 |
| | | hoffmannii | | | | | | |

Using biological method for coloring wood with fungi is a new innovative approach and has a potential to produce preferable wood colors and patterns. The resultant product could be sold as a water based stain substitute in the form of fungal spore suspension. One litre of such suspension is relatively inexpensive, and can be further diluted into 100 L with water as application solution. In an industrial factory application situation, the product can be applied to lumber either by a spraying line or by a dipping tank, which will consume 20 L or 50 L of application solution per thousand board feet measure (Mfbm) of lumber, respectively. Applying the product to lumber at an industrial scale will lead to a cost effective product. After application of the fungal suspension onto lumber, the lumber must be stored in a yard for more than 1 week to allow fungus changing wood color. Of course, this process will take longer time than standard water-based staining methods; however, the process allows color change in depth of wood, whereas the standard staining method can not. Such technology will increase wood market value and enhance the utilization of wood products in competitive marketing of lumber and furniture manufacturing.

### References

Billmeyer, F. W. and M. Saltzmann, 1981, Principles of color Technology, 2^{nd} Ed. John Wiley end Sons Inc., NY, 240 pp.
Haeghen, Y. V., J. M. Naeyaert, I. Lemahieu and W. Phillips, 2000, An imaging system with calibrated color image acquisition for use in dermatology, IEEE Transactions on Medical Imaging, 19(7):722-30.
Rodolfo, C. T. Livio, A. Ottaviano, 2007, White beech: a tricky problem in the drying process, ISCHP'07, p. 135-140.
H. Sugawara et al. (Editor), Bacteria, Fungi and Yeasts, 4th Edition, 1993. World Discovery of Collection of Cultures of Microorganism, WFCC World Data Center on Microorganisms.

1. A method of coloring and treating wood with a pigmented fungal species, the method comprising:
providing the fungal species in an active form is selected from the group consisting of Penicillium variabile; Fusarium culmorum; Coryne microspora; Diatrypella placenta; Arthrographis cuboidea; Poria aurea; Corticium polosum; Lentinus cyathiformis; Lecythophora hoffmannii; Tyromyces balsameus; Trogia crispa; Polyporus dryophilus; Polyporus dryophilus var. vulpinus; Peniophora piceae; Sporotrichum dimorphosporum; Gliocladium verticilloides; Nectria ochroleuca; Trichoderma atroviride; Trichoderma sp; Verticillium sp; Chlorosplenium aeruginascens; Scytalidium lignicola; Ophiostoma piceae; Aureobasidium pullulans; Phialophora alba; Penicillium expansum; Penicillium implicatum; Fusarium verticillioides; Dactylium dendroides; Phialemonium dimorphosporum, Fusarium oxysporum, Ascocoryne cylichnium; Cephalotheca purpurea and combinations thereof;
wherein the active form comprises incubating the fungal species to produce a fungal culture, and homogenizing the culture to produce a suspension;
wherein the suspension comprises a concentration of spores/myocella fragments per ml of suspension of from 1×10⁶ to 1×10⁸,
providing the wood to be treated;
applying the active form of the fungal species to the wood to produce a treated wood;
incubating the treated wood for a period of time;
drying the treated wood.

2. (canceled)

3. (canceled)

4. (canceled)

5. (canceled)

6. The method of claim 1, wherein providing the wood to be treated is sapwood and/or heartwood of sugar maple, white birch or yellow birch.

7. The method of claim 1 or 2, wherein applying the active form of the fungal species to the wood is by dipping, by spraying or by brushing.

8. The method of claim 3, wherein applying the active form of the fungal species to the wood is by dipping.

9. The method of claim 1, wherein incubating treated wood for a period of time is for more than 1 week at a temperature from 5° C. to 35° C. and a relative humidity at least 75% or higher.

10. The method of claim 9, wherein the treated wood is incubated at 25° C. and 75% RH for 1 to 4 weeks.

11. The method of claim 1, wherein drying the wood is at a temperature from 50° C. to 105° C.

12. The method of claim 1, wherein wood color change is evaluated visually or with a colorimeter.

13. A fungal species treated wood product produced by a method comprising:
providing the fungal species in an active form;
wherein the fungal species is selected from the group consisting of Penicillium variabile; Fusarium culmorum; Coryne microspora; Diatrypella placenta; Arthrographis cuboidea; Poria aurea; Corticium polosum; Lentinus cyathiformis; Lecythophora hoffmannii; Tyromyces balsameus; Trogia crispa; Polyporus dryophilus; Polyporus dryophilus var. vulpinus; Peniophora piceae; Sporotrichum dimorphosporum; Gliocladium verticilloides; Nectria ochroleuca; Trichoderma atroviride; Trichoderma sp; Verticillium sp; Chlorosplenium aeruginascens; Scytalidium lignicola; Ophiostoma piceae; Aureobasidium pullulans; Phialophora alba; Penicillium expansum; Penicillium implicatum; Fusarium verticillioides; Dactylium dendroides; Phialemonium dimorphosporum, Fusarium oxysporum, Ascocoryne cylichnium; Cephalotheca purpurea and combinations thereof,
providing the wood to be treated;
applying the active form of the fungal species to the wood to produce a treated wood;
incubating the treated wood for a period of time;
drying the treated wood, wherein the ΔE*ab color difference value range from 25.2 to 73.6.

14. (canceled)

15. The product of claim 9, wherein the wood product is a sapwood and/or heartwood of sugar maple, white birch, or yellow birch.
